(19) United States
(12) Patent Application Publication
(10) Pub. No.: US 2008/0175385 A1
(43) Pub. Date: Jul. 24, 2008

(54) QKD system with link redundancy

(75) Inventors: Keun Lee, Newburyport, MA (US); Audrius Berzanskis, Cambridge, MA (US)

Correspondence Address: OPTICUS IP LAW, PLLC, 7791 ALISTER MACKENZIE DRIVE, SARASOTA, FL, 34240, US

(73) Assignee: MAGIQ TECHNOLOGIES, INC.

(21) Appl. No.: 12/009,039

(22) Filed: Jan. 16, 2008

Related U.S. Application Data
(60) Provisional application No. 60/880,975, filed on Jan. 18, 2007.

(51) Int. Cl. H04L 9/08; H04K 1/00; H04B 10/20

(52) U.S. Cl. 380/256; 380/278

(57) ABSTRACT

A QKD system having QKD link redundancy between two sites, with the system having only one QKD station at each site, and with two or more QKD links operably coupled to the QKD stations. The QKD stations have respective optical switches that are optically coupled to both QKD links and that are controlled by respective controllers in each of the QKD stations. If one of the QKD links fails or has trouble transmitting optical signals, the QKD switches are switched so that the optical path between the QKD stations uses the remaining QKD link. This arrangement requires only two QKD stations rather than the four QKD stations as presently taught in the prior art.

### CLAIM OF PRIORITY

This application claims the benefit of priority under 35 U.S.C. § 119(e) from U.S. Provisional Patent Application Ser. No. 60/880,975, filed on Jan. 18, 2007.

### FIELD OF THE INVENTION

The present invention relates generally to quantum key distribution (QKD), and in particular relates to systems and methods for providing communication link redundancy between QKD stations of a QKD system without having to add additional QKD stations.

### BACKGROUND ART

QKD involves establishing a key between a sender (“Alice”) and a receiver (“Bob”) by using either single-photons or weak (e.g., 0.1 photon on average) optical signals (pulses) called “qubits” or “quantum signals” transmitted over a “quantum channel.” Unlike classical cryptography whose security depends on computational impracticality, the security of quantum cryptography is based on the quantum mechanical principle that any measurement of a quantum system in an unknown state will modify its state. Consequently, an eavesdropper (“Eve”) that attempts to intercept or otherwise measure the exchanged qubits introduces errors that reveal her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in U.S. Pat. No. 5,307,410 to Bennett (which patent is incorporated herein by reference), and in the article by C. H. Bennett entitled “Quantum Cryptography Using Any Two Non-Orthogonal States”, Phys. Rev. Lett. 68 3121 (1992). The general process for performing QKD is described in the book by Bouwmeester et al., “The Physics of Quantum Information,” Springer-Verlag 2001, in Section 2.3, pages 27-33.

The simplest form of QKD system for providing encrypted communication between two different sites has a first QKD station Alice at the first site and a second QKD station Bob at the second site. Alice and Bob are operably coupled to one another by a single optical fiber link.

thas been proposed that doubling the encryption bandwidth while also providing redundancy between the sites can be achieved by providing two Alices (Alice 1 and Alice 2) at the first site and two Bobs (Bob 1 and Bob 2) at the second site. A first communication link connects Alice 1 and Bob 1 (the first QKD station pair) and a second communication link connects Alice 2 and Bob 2 (the second QKD station pair) Thus, if one of the communication links fail, the QKD station pair and its corresponding link provides redundancy. However, this approach is expensive because it requires a total of four QKD stations.

### SUMMARY OF THE INVENTION

One aspect of the invention is to provide a QKD system having QKD link redundancy between two sites by providing two QKD links operably coupled to a single transmitting QKD station Alice and a single receiving QKD station Bob. Alice and Bob are optically coupled to respective optical switches that are also optically coupled to both QKD links. The QKD switches are adapted to switch between the QKD links so that optical communication between Alice and Bob is maintained even if one of the QKD links fails. This arrangement requires only two QKD stations rather than the four QKD stations as presently taught in the prior art.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed.

### BRIEF DESCRIPTION OF THE DRAWINGS

FIG. 1 is schematic diagram of a QKD system having a first QKD station Alice at a first site (Site A) and a second QKD station at a second site (Site B), with the two QKD stations optically coupled by two communication links;

FIG. 2 is a close-up schematic diagram of an example embodiment of the QKD station Alice of the QKD system of FIG. 1; and

FIG. 3 is a close-up schematic diagram of an example embodiment of the QKD station Bob of FIG. 1.

The accompanying drawings are included to provide a further understanding of the invention, and are incorporated into and constitute a part of this specification. The drawings illustrate various embodiments of the invention and together with the description serve to explain the principles and operations of the invention. Whenever possible, the same reference numbers or letters are used throughout the drawings to refer to the same or like parts.

### DETAILED DESCRIPTION OF THE PREFERRED EMBODIMENTS

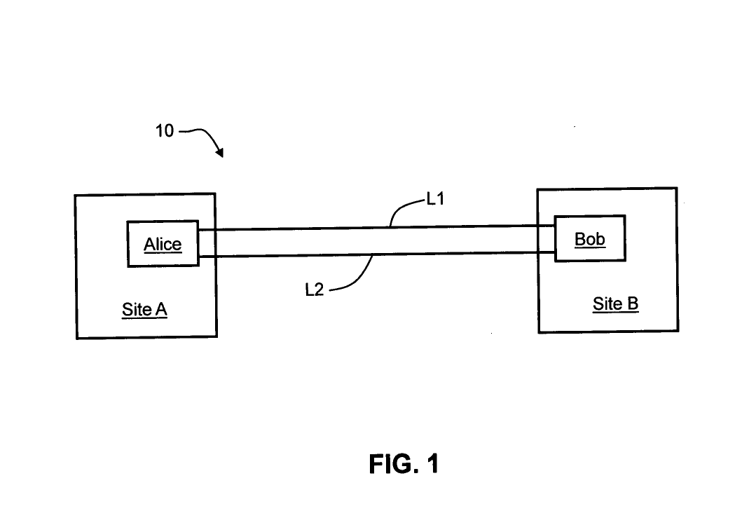

FIG. 1 is schematic diagram of a QKD system 10 having a first transmitting QKD station Alice at a first site (Site A) and a second receiving QKD station Bob at a second site (Site B), with the two QKD stations optically coupled by two communication links (“links”) L1 and L2. For the purposes of discussion herein, link L1 is considered the “primary” link and link L2 is considered the “secondary” QKD link. In an example embodiment of the present invention, one or both of links L1 and L2 are or include optical fibers. In another example embodiment, links L1 and L2 are free-space links.

### Alice

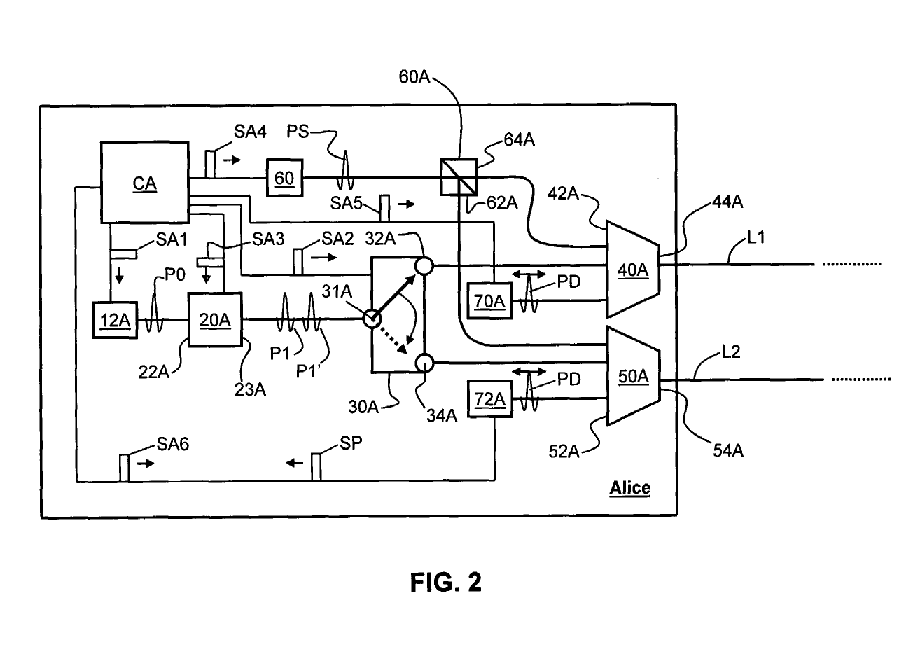

FIG. 2 is a close-up schematic diagram of an example embodiment of the QKD station Alice of QKD system 10 of FIG. 1. Alice includes a light source 12A adapted to generate either single photons or weak photon pulses P0. An encoding optical system 20A having an input end 22A and an output end 23A is optically coupled to light source 12A at input end 22A. Encoding optical system 20A is adapted to form encoded (e.g., phase- or polarization-encoded) single-photon-level light pulses P1 from incoming light pulses P0. In an example embodiment, encoding optical system 20A is or includes an interferometer loop such as those used in the aforementioned U.S. patent to Bennett. In the example embodiment shown in FIG. 2, encoding optical system 20A generates two coherent pulses P1 from each initial pulse P0, and encodes one of the pulses P1 to form an encoded pulse, indicated as P1′. In an example embodiment, encoding optical system 20A includes a modulator (not shown), such as a polarization modulator or a phase modulator.

Alice also includes an optical switch 30A that has an input port 31A and two output ports 32A and 34A. Optical switch 30A is optically coupled to output port 23A of encoding optical system 20A at optical switch input port 31A. Optical switch 30A is adapted to switch between outputs 32A and 34A, allowing the QKD system (or the QKD system user) to select link L1 or L2 in the optical path between Alice and Bob.

Alice also includes two wavelength-division multiplexers (WDMs) 40A and 50A. WDM 40A has an input end 42A and an output end 44A, while WDM 50A has an input end 52A and an output end 54A. Input end 42A of WDM 40A is optically coupled to output port 32A of optical switch 30A. Likewise, input end 52A of WDM 50A is optically coupled to output port 34A of optical switch 30A. The respective output ends 44A and 54A of WDMs 40A and 50A are optically coupled to respective links L1 and L2.

Alice also includes a framing/synchronization (F/S) light source 60 optically coupled to a beamsplitter 60A that has two output ends 62A and 64A. Beamsplitter output end 62A is optically coupled to input end 52A of WDM 50A, while beamsplitter output end 64A is optically coupled to input end 42A of WDM 40A. F/S light source 60 is adapted to provide classical (i.e., non-quantum) light pulses (F/S signals) PS for synchronization and framing of the single-photon-level quantum signals used in establishing a key between Alice and Bob. Alice also includes two public discussion channel interfaces 70A and 72A that are respectively optically coupled to respective WDM input ends 42A and 52A. WDM 40A and 50A operate in both directions for PD signals to support bi-directional public discussion.

Alice also includes a controller CA operably coupled to light source 12A, encoding optical system 20A, optical switch 30A, F/S light source 60, and pubic discussion channel interfaces 70A and 72A. In an example embodiment, controller CA is a computer or field-programmable gate array (FPGA). Controller controls light source 12A via control signals SA1, encoding optical system 20A via control signals SA3, optical switch 30A via control signals SA2, FS light source 60 via control signals SA4, and public discussion channel interfaces via control signals SA5 and SA6. Controller CA is adapted to receive and process signals PD send over the public discussion channels.

### Bob

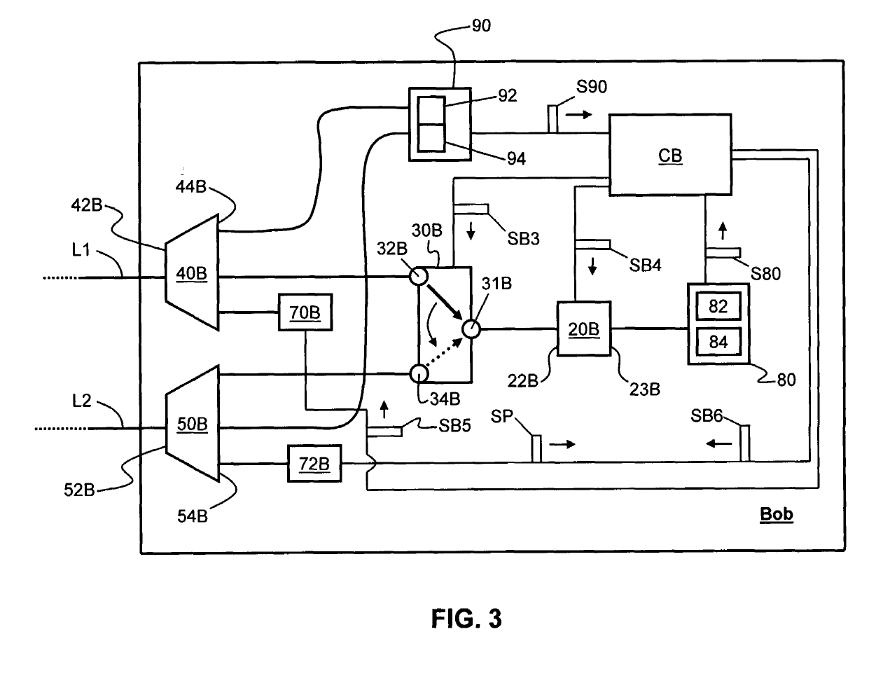

FIG. 3 is a close-up schematic diagram of an example embodiment of the QKD station Bob of FIG. 1. Bob includes WDMs 40B and 50B with respective input ends 42B and 52B respectively optically coupled to links L1 and L2. Bob also includes an optical switch 30B similar (if not identical) to optical switch 30A, but arranged so that port 31B is an output port and ports 32B and 34B are input ports that are selected by changing the state of the optical switch. WDM 40B is optically coupled at its output end 44B to optical switch input port 32B and WDM 50B is optically coupled at its output end 54B to optical switch input port 34B. Bob also includes two public discussion channel interfaces 70B and 72B that are respectively optically coupled to the output ends 44B and 54B of WDMs 40B and 50B so that they can communicate with their counterparts 70A and 72A at Alice. WDM 40B and 50B operate in both directions for PD signals to support bi-directional public discussion.

Bob further includes an encoding optical system 20B similar if not identical to Alice's encoding optical system 20A, and having an input end 22B and an output end 23B. Optical switch output port 31B is optically coupled to input end 22B of encoding optical system 20B. Encoding optical system 20B is adapted to modulate encoded quantum signals sent from Alice. In an example embodiment, encoding optical system 20B is adapted to modulate one of the quantum signals P1 and P1′ and then interfere these signals to form an interfered quantum signal that includes information about the encoding applied by Alice and Bob.

Bob further includes a single-photon detector (SPD) unit 80 that includes in an example embodiment two SPDs 82 and 84. SPD unit 80 is optically coupled to output end 23B of encoding optical system 20B and adapted to receive and detect optical signals (e.g., the interfered optical signal) from the encoding optical system. The interfered optical signal arrives either at one SPD (say, SPD 82), resulting in qubit value 0 or arrives at the other SPD (SPD 84), resulting in qubit value 1.

Bob further includes a framing/synchronization (F/S) detector unit 90 optically coupled to the respective output ends 44B and 54B of WDMs 40B and 50B so as to be in optical communication with F/S light source 60 via links L1 and L2. In an example embodiment, F/S detector unit 90 includes separate detectors 92 and 94 corresponding to WDMs 40B and 50B and thus links L1 and L2, respectively.

Bob also includes a controller operably coupled to optical switch 30B, public discussion channel interfaces 70B and 72B, SPD unit 80, and F/S detector unit 90. Bob uses control signals SB3, SB4, SB5 and SB6 to control optical switch 30B, encoding optical system 20B, and public discussion channel interfaces 70B and 72B, respectively. Bob also receives an SPD unit signal S80 and a F/S detector unit signal S90 from the SPD unit 80 and the F/S detector unit 90, respectively. Controller CB also adapted to receive and process signals PD send over the public discussion channels between Alice and Bob.

### Method of Operation

In an example embodiment, QKD system 10 operates as usual, with the optical switches 30A and 30B at Alice and Bob set so that the optical path associated with the primary link L1 is selected (e.g., as the default link). Alice transmits identical F/S pulses PS over both links L1 and L2, and pulses PS are detected at F/S detector unit 90 (e.g., in respective detectors 92 and 94). The F/S pulses are converted to F/S detector unit signals S90, which are received and processed by controller CA and CB. F/S pulses PS are thus used to establish the timing and synchronization of the encoding and detection of the quantum signals P1 so that the QKD protocol can be carried out.

Each link L1 and L2 also carries public discussion signals PD generated by public discussion channel interfaces 70A and 70B (link L1) and 72A and 72B (link L2) over their respective public discussion channels. These public discussion signals PD are converted to electrical signals SP by the respective interfaces 70A, 70B and 72A, 72B, and are processed by controllers CA and CB in carrying out the particular QKD protocol.

When both links L1 and L2 operate without failure or transmission problems, both public discussion channels are available for use with the particular QKD protocol, and either channel may be used. This mode of operation of QKD system 10 essentially identical to that for single-QKD-link architecture.

### Failure of a QKD Link

In the operation of QKD system 10, primary link L1 used to communicate quantum signals QS (i.e., signals P1) between Alice and Bob is also called the active link, while the unselected link L2 is called the standby link.

Bob detects F/S signals PS for both the primary link L1 and the secondary link L2. If correct framing/synchronization patterns are not detected for a pre-determined period of time T₁, Bob declares a failure of the corresponding link. In another example embodiment, the QKD link status of the public discussion channel is used as the link-failure indicator. The choice depends on the speed and reliability of the failure indication. For the purpose of illustration, the framing/synchronization method is used and discussed. The failed status of the link is cleared after receiving correct framing/synchronization patterns from F/S pulses PS for a time T₂.

### Switching Links

As discussed above, controllers CA and CB are adapted to control the state (switching position) of their respective optical switches 30A and 30B via control signals SA3 and SB3 so that the optical path between Alice and Bob uses either link L1 or L2.

In an example embodiment, the rules for the switching optical switches 30A and 30B are as follows:
1. If the active link (L1) fails and the standby link (L2) has not failed, make the standby link the new active link.
2. If the failed primary link (L1) recovers from failure:
   a. If the system is set to a revertive mode and the currently active link is the secondary link (L2), then switch back to the primary link (L1).
3. If the link protection is disabled by a user, do not switch over.
4. If a user issues a manual switch over, switch to the standby link if it has not failed.
5. If a user issues a “forced” switch over, switch to the standby link unconditionally.

Alice and Bob must agree to select the same link. Since QKD requires the public discussion channel to be in operation at all times, it is most flexible to use the public discussion channel to coordinate the action of both stations. The following simple protocol accomplishes the goal.
1. If the standby public discussion channel has not failed, select the standby link for the public discussion. Otherwise select the active link.
2. The receiver Bob decides the proposed new active link, new_active_link, to be primary (L1) or secondary (L2).
3. The receiver Bob sends a “switch to new_active_link” message to the transmitter Alice.
4. The transmitter Alice replies with “switch_accept” or “switch_deny” message. After sending the switch_accept message, the transmitter Alice switches to the new_active_link immediately. If the switch is denied, the reason is included in the reply message.
5. The receiver Bob switches after receiving the switch_accept reply from the transmitter Alice. Otherwise the switch-over is aborted.

An advantage of the QKD system 10 of the present invention is that it does not require two transmitting and two receiving QKD stations to have redundant encrypted communication between Site A and Site B. Redundancy is not only provided with respect to the quantum signals, but is also included in the QKD stations with respect to the frame/synchronization channel and the public discussion channels. While this requires substantial modifications to the two direct-link QKD stations, the modifications obviate the need for additional QKD stations to accomplish system redundancy.

Note that in another example embodiment of QKD system 10, optical switch is a 1×N switch, wherein N is 2 or greater, and the number of links between Alice and Bob is two or greater. Extension of the above-described QKD system from two links L1 and L2 to more than two links follows directly from the teaching provided herein.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A QKD system with QKD-link redundancy, comprising:
a transmitting QKD station Alice having a first optical switch;
a receiving QKD station Bob having a second optical switch;
first and second QKD-links that optically connect Alice to Bob at said first and second optical switches that allow Alice and Bob to select the first or second QKD link to transmit quantum signals between them.

2. A method of performing QKD with link redundancy, comprising:
establishing first and second optical links between first and second QKD stations Alice and Bob;
providing a first optical path between Alice and Bob that includes the first optical link, wherein quantum signals for establishing a quantum key between Alice and Bob are sent over the first optical path; and
if a transmission problem is detected in the first optical path, switching optical links between Alice and Bob to the second optical link so as to establish a second optical path that allows Alice and Bob to communicate with quantum signals.

3. The method of claim 2, including switching optical paths by switching respective first and second optical switches at Alice and Bob.

4. The method of claim 2, including sending framing/synchronization signals over both the first and second optical links.

5. The method of claim 2, including sending public channel information over both the first and second optical links.
